(19) United States
(12) Patent Application Publication
(10) Pub. No.: US 2014/0272074 A1
(43) Pub. Date: Sep. 18, 2014

(54) CRUMBLE PROCESS CHEESE PRODUCTS AND METHODS OF PRODUCTION

(71) Applicant: LAND O'LAKES, INC., Arden Hills, MN (US)

(72) Inventors: Jason Thompson, Robbinsdale, MN (US); Thomas Alexander Glenn, Shoreview, MN (US)

(73) Assignee: LAND O'LAKES, INC., Arden Hills, MN (US)

(21) Appl. No.: 13/828,704

(22) Filed: Mar. 14, 2013

(51) Int. Cl. A23C 19/08

(52) U.S. Cl. CPC A23C 19/08
USPC 426/582

(57) ABSTRACT

Crumble process cheese products may be produced by cooling process cheese to freezing temperatures below about 32° F. and holding the process cheese at the freezing temperatures for a sufficient amount of time to cause a freeze-induced denaturation of the protein bonds in the process cheese, thereby providing a modified process cheese with a texture adapted to crumble. A crumble process cheese product may include an emulsion of an emulsifier, protein, water and oil, with a portion of the protein bound to the oil and the water in the emulsion, and another portion of the casein is bound to the oil and is unbound to the water, thereby providing the crumble cheese product with a crumble-like texture.

### FIELD OF THE INVENTION

The present disclosure relates to crumble process cheese products and methods of producing these products.

### BACKGROUND

Cheese varieties such as cotija, queso fresco, feta and blue cheeses typically are provided in crumble form or readily crumble during food preparation by the end user. The manufacture of these natural crumble cheeses typically involves an aging process taking several weeks. In addition, if not pasteurized, these cheeses may harbor bacteria such as Listeria, which may be harmful if ingested. Further, queso fresco cheese is highly perishable and must be refrigerated or used immediately upon its production. For blue cheese, added mold and cultivated bacteria provide the aged blue cheese with its distinctive flavor and odor. However, this mold and bacteria can be harmful to some, and if the cheese is not properly aged, unintended bacteria may develop during the aging process, which may cause fouling.

### SUMMARY

In view of the foregoing, provided herein are crumble process cheeses and processes for manufacturing crumble process cheeses that avoid the downfalls of natural crumble cheese.

According to one implementation, a method of producing a crumble process cheese involves forming process cheese containing an oil-in-water emulsion with protein bound to water and oil and cooling the process cheese to a freezing temperature below about 32° F. during an equilibration period, the equilibration period sufficient to cause a freeze-induced protein denaturation thereby producing a modified process cheese comprising a texture adapted to crumble.

In another implementation, a crumble process cheese product includes an emulsifier, protein, water and oil, with a portion of the protein formed of casein, which is bound to the oil and the water in an emulsion, and another portion of the casein is bound to the oil and is unbound to the water, thereby providing the crumble cheese product with a crumble-like texture.

### BRIEF DESCRIPTION OF THE DRAWINGS

FIG. 1 illustrates a block diagram of a method for producing crumble process cheese according to certain aspects of the present disclosure.

### DETAILED DESCRIPTION

Overview:

Aspects of the present disclosure provide crumble process cheese products, which may serve as a replacement for natural crumble cheeses (e.g., natural cotija, queso fresco, feta and blue cheeses) and for other natural cheeses that do not necessarily crumble but where it is desirable to provide a crumble process cheese product. The crumble process cheese may be formed by freezing process cheese and holding the cheese at freezing temperatures for a period sufficient to fracture protein bonds within the cheese.

Crumble Process Cheese Products:

In some aspects, the crumble process cheese products may include a composition substantially similar to commonly available process cheeses. However, unlike typical process cheese, which has a relatively smooth texture, crumble process cheese may have a grainy or crumbly texture similar to that of natural crumble cheese. The crumble-like texture of the process cheese may be due to protein structures within the process cheese being unbound to water contained therein or bound differently to the water compared to typical process cheese. This results in a disruption of the emulsified oil and water components within the process cheese, which imparts the grainy or crumble-like texture to the process cheese.

Crumble process cheese products may be formed of an oil-in-water emulsion containing cheese such as cheddar cheese, enzyme modified cheeses (e.g., for matching the flavor of the natural cheese replaced) and emulsifying salts (e.g., sodium phosphate, potassium phosphate or both). Other components may include additional fat compositions such as cream, anhydrous milk fat, dehydrated cream, buttermilk; non-fat dry milk (or skim milk); milk protein concentrate; whey protein concentrate; gums; water; salt; minor components (e.g., artificial colors, flavorings, antimyocotic agents, lecithin); and acids or bases for adjusting the pH of the process cheese.

The oil-in-water emulsion includes an oil phase containing fats and oil-soluble substances and an aqueous phase containing a solution of water and water-soluble substances. In process cheese, these phases form a stable emulsion due to proteins in the cheese being soluble in both the oil and the aqueous phases thereby forming a stable emulsion of protein, oil and water. More particularly, caseins forming a portion of the protein in the cheese are modified in the presence of an emulsifying salt to include hydrophilic water-soluble regions and hydrophobic fat-soluble regions due to the displacement of calcium in the casein, which has a higher affinity for the emulsifying salts. This increases the emulsifying capacity of casein and facilitates the interaction between the oil and aqueous components in the cheese, thus stabilizing the mixture of oil, water and protein providing the process cheese with a uniform consistency and a smooth texture. In the crumble process cheese products, the emulsification between the casein and water in the aqueous phase is disrupted, while the bonds between the casein and oil remain in an emulsified state. This disruption between the casein and water bonds changes the consistency of the process cheese resulting in a separation of the cheese components and imparts crumble-like texture to the crumble process cheese. Such a crumble-like texture may be provided by some of the casein within the cheese being unbound from water, while other portions of the casein may continue to form a stable oil-in-water emulsion. This is in contrast to natural cheese, where, as a natural cheese ages, the bonds between oil and casein break down, e.g., by enzymes and bacteria, thereby decreasing the ability of casein to emulsify with oil resulting in natural crumble cheese.

The crumble process cheese products of the present disclosure may include various moisture, fat and protein contents, and its pH may vary based on, for example, the type of cheese, type of emulsifying salt and whether an acid or a base is added to the process cheese. Accordingly, the crumble products of the present disclosure may include a variety of crumble-like textures with varying levels of graininess. In some implementations, the crumble products may include a moisture content of about 33 to about 42 percent by weight of the product. In further implementations, the moisture content may be about 1 percent greater than the moisture content of the natural cheese counterpart to the crumble product. The fat content, e.g., within the oil phase, may be about 25 to about 34 percent fat by weight of the product. The protein content may be about 15 to about 24 percent protein by weight of the product, where protein in the form of casein accounting for about 13 to 22 percent protein by weight of the product. In some implementations, a protein content of at least about may result in a crumble cheese product with a crumble level similar to its natural cheese counterpart. Protein, e.g., casein, is the main structural component in the product, and when ice crystals form, the crystals disrupt protein bonds resulting in a similar amount of crumbles compared to the natural cheese counterpart. In addition, by using a lower moisture content process cheese, e.g., at levels below 36 percent, the crumbles may be firmer, e.g., less moist, which may be similar to the natural cheese counterpart.

The crumble products may have a pH of about 5.4 to about 6.1, with a pH of about 5.4 to about 5.6 being preferred. Particularly, due to the buffering capacity of the process cheese components, modifying the pH beyond these ranges generally requires relatively large quantities of acids or bases, which can create an unacceptable flavor in the product. Thus, although a crumble-like texture may be achieved through producing process cheese with a pH below about 5.0 to thereby weaken protein-protein bonds but can result in off flavors, the crumble process cheese of the present disclosure results from a freeze-induced protein denaturation, discussed below.

In addition to the benefit of the crumble process cheese products serving as an alternative to natural crumble cheeses, these products may provide benefits due to their reduced cost, ability to be tailored for flavor beyond natural cheeses, longer shelf life and reduced microbial concerns.

Methods of Forming Crumble Process Cheese:

FIG. 1 illustrates a block diagram of a method 100 of forming crumble process cheese according to certain aspects of the present disclosure. In method 100, process cheese may be formed 110, for example, using a batch or continuous process. Production of the process cheese may involve blending natural cheese, flavored enzyme modified cheese, dairy powder, milkfat, pH modifiers and water at ambient temperatures until homogenous. The homogenous mixture may be heated through steam injection followed by adding emulsifying salts to the mixture after about one minute of heating. The emulsified blend may be cooked to pasteurization temperatures, such as 165° F., and held for a pasteurization period, such as for about 30 seconds. The pasteurized blend may form a molten, plastic mass of protein, water and oil in a stable oil-in-water emulsion, in part, due to the emulsifying ability of caseins in the process cheese. The process cheese may include any of the various compositions described above and may generally have uniform consistency that is adapted to retain its form.

The molten mass of process cheese may optionally be transferred to a filler/hopper where the process cheese may be divided 120 into individual units such as through depositing the cheese into a pouch (e.g., a film pouch within a loaf box) for further processing. For example, the process cheese may be formed into blocks, disks, or loaves; may weigh 2, about 3, about 4 or about 5 pounds; and may be packaged or unpackaged.

The process cheese may be further processed by cooling 130 the process cheese to a freezing temperature below about 32° F. during an equilibration period, which is discussed below. Freezing temperatures may be reached by placing the process cheese in a temperature-controlled environment. Freezing may involve rapid cooling to promote the formation of small ice crystals in the process cheese; or may involve slow cooling to promote the formation of large ice crystals. In a particular example, chilled air may be circulated directly over the process cheese (e.g., with or without packaging) for rapid cooling. In another example, the process cheese may be slowly cooled by placing the process cheese in an insulated environment (e.g., a cooler), which is exposed to the chilled, circulating air, resulting in a longer equilibration period compared to direct exposure. The freezer or other cooling environment may be held at the target equilibration temperature or the temperature may be stepped down to such a temperature. However, holding the cooling environment at the equilibration temperature may be preferred. For example, the environment may be held at any of the target temperatures of the present disclosure. In addition, cooling the process cheese may involve the use of circulating or non-circulating air environments.

In some aspects, just prior to introduction into the cooling environment, the cheese may have a temperature at or near pasteurization temperatures, such as from about 140° F. to about 165° F., and preferably at about 160° F. to about 165° F. Alternatively, the process cheese may be allowed to initially cool to temperatures below pasteurization temperatures, such as down to ambient temperatures, e.g., about 70° F., prior to cooling.

The process cheese may be cooled to a freezing temperature from below about 32° F. to about −20° F. or about 32° F. to about −20° F. or any temperature range therebetween. For example, the freezing temperature may be about 32° F., 24° F., 4° F., 0° F., −4° F., −20° F. or −24° F. In some aspects, a freezing temperature of about −20° F. (e.g., from about −18 to about −20° F.) is preferred. However, a range of freezing temperatures imparts desirable crumble-like properties to the modified process cheese and the preferred freezing temperature should not be construed as limiting. During cooling, the process cheese may be arranged in an insulated or a non-insulated container. In some implementations, non-insulated containers may be preferred in order for the process cheese to rapidly cool when exposed to the cooling environment.

As mentioned above, cooling may take place over the course of an equilibration period. This period may involve continuous cooling for about or at least about 18 hours. For example, this period may be about 18, 24, 36, 45, 55, 72, 96, 120, 144 or 168 hours. In a particular example, process cheese loaves weighing about 2 pounds to about 5 pounds may be placed in a temperature cooled environment and may be cooled to a temperature of about −20° F. over the course of a period of at least about 120 hours.

During and upon freezing, the process cheese may begin to expand, in part, due to moisture expansion resulting in the formation of ice crystals in the process cheese. This disrupts the protein structure resulting in a freeze-induced protein denaturation. In particular, the expansion process may result in the water-casein bonds breaking, which disrupts the emulsification of the process cheese, thereby providing a modified process cheese with a texture adapted to crumble. The frozen process cheese may continue to expand during the equilibration period as the cheese approaches the freezing temperatures provided herein.

The frozen process cheese with the modified texture may be brought up to refrigeration temperatures 140, e.g., about 38° F. to about 40° F., and held for at least 24 to 36 hours to cause the moisture in the cheese to transition to a liquid state and reabsorb into the cheese matrix. Because the proteins have been denatured by the freezing process, the water will not rebind to the protein in the original state of the process cheese. Rather, water may be reabsorbed by the cheese matrix, which could include proteins, but the water would not be bound to the protein in the same manner as in the original state of the process cheese. At these refrigeration temperatures, the product retains its modified texture and may easily crumble upon end use. In addition, as typical storage and transport temperatures are at refrigeration temperatures, the product may be easily handled upon reaching these temperatures.

The resulting crumble process cheese, if unpackaged during the preceding processes, may be packaged 150 using one or more packaging device. For example, the process cheese product may be packaged in any desirable shape at any point after make, or the freeze-induced protein denatured product may be crumbled, such as through hand crumbling or by utilizing a food processor, and then packaged.

The methods for forming crumble process cheese of the present disclosure may provide advantages over the traditional methods of producing natural crumble cheese. For example, crumble process cheese products may be formed in a matter of days using methods that are consistent and easily repeatable. In addition these methods do not require ripening agents. In contrast, natural crumble cheeses typically take weeks to age and may require ripening agents to develop their crumble texture. Aspects of the present disclosure may thus result in reduced inventory costs from the elimination of aging time and increased throughput. In addition, crumble process cheese may have a longer shelf life compared to natural cheese. Further, due to the increased safety of pasteurized process cheeses, and with the perceived enhanced flavor of crumbly cheese, providing a crumbly texture to process cheese may provide a safe and palatable cheese product.

The following examples illustrate three trials in which crumble products were produced. These examples are provided by way of illustration and should not be construed as limiting as those skilled in the art will appreciate various modifications of the present examples fall within the spirit and scope of the present disclosure.

### EXAMPLES

Process cheese products were subjected to various cooling conditions while being temperature-monitored in three trials in order to identify processes for modifying process cheese products that mimic the crumble-like texture of natural crumble cheese.

Methods and Materials

Process cheese was made according to typical process cheese production procedures, divided into 5 lb. loaves and subjected to one of six freezing conditions below 32° F.: slow freezing to 24° F., fast freezing to 24° F., slow freezing to 0° F., fast freezing to 0° F., slow freezing to −20° F., and fast freezing to −20° F. In slow freezing to 24° F., samples reached 24° F. after about 113 hours. In fast freezing to 24° F., samples were frozen at 24° F. after about 36 hours. For slow freezing to 0° F., samples reached 0° F. after about 168 hours. For fast freezing to 0° F., samples reached 0° F. after about 98 hours. For slow freezing to −20° F., samples reached this freezing temperature after about 216 hours. For fast freezing to −20° F., samples reached −20° F. after about 120 hours. In slow freezing to 24° F., −4° F. and −20° F., samples were placed in an insulated cooler and stored at these respective temperatures. In fast freezing to 24° F., −4° F., and −20° F., samples were put directly into storage without any insulation at these respective temperatures. The samples were stored at these conditions for 5 days, after which all product samples were stored at normal refrigeration conditions, e.g., 38-40° F., for at least two days until evaluation. Product samples were monitored for temperature during initial cooling and subsequent refrigeration storage using temperature data recorders with probes inserted into the process cheese samples shortly after being packaged.

All product samples were tested for performance and chemical composition and included analysis of moisture content, fat content, salt content and pH level. Performance testing involved comparing the process cheese samples to natural cheeses with crumbly textures such as: cotija, queso fresco, and feta. The crumble products were tested for their crumble-like texture using a food processor and by hand crumbling. The crumbled products were then compared to natural crumble cheese controls based on their similarity in appearance.

Trial 1:

In the first trial, upon make, process cheese samples were cooled in four different environments: slow freeze to 24° F.; fast freeze to 24° F.; slow freeze to 0° F.; and fast freeze to 0° F. Compositional analysis results of the samples of Trial 1 are provided in Table 1. Performance evaluation showed that samples stored at 24° F. produced crumbles that were more moist and beady compared to natural cheese crumbles. Fast freeze to 0° F. samples appeared like the crumbles of a natural cheese when hand crumbled and put through a food processor.

Trial 2:

The second trial additionally focused on using more extreme cooling conditions in which samples were subjected to slow and fast freezing at −20° F. using circulating air. Compositional analysis results of the samples of Trial 2 are provided in Table 1. The samples of this trial contained lower moisture content and pH compared to the samples of Trial 1. Performance testing showed improvements for the samples with the lowered moisture content and pH levels. In addition, differences in performance of samples subjected to freezing at −20° F. (slow and fast) were observed. Cotija samples subjected to fast freezing at −20° F. conditions had a crumble-like texture and appeared the most like its natural cheese counterpart. This may be due to the lower moisture content, e.g., about 37 percent, of the cotija samples compared to the queso fresco samples at about 39, percent along with the lower pH, e.g. below about 5.7 for cotija compared to about 5.8 for queso fresco. Based on the results of Trial 2, fast freezing at −20° F. may provide a crumble product with a desired texture when the process cheese composition includes a moisture content of less than 38 percent and a pH below 5.7.

Trial 3:

The third trial looked at manipulating pH in order to find an optimal range that produced crumbly cheese that looked like a natural cheese. The fast freezing to −20° F. cooling conditions were used for all samples based on the performance results from the second trial. Compositional analysis results of the samples of Trial 3 are provided in Table 1. Due to buffering components usually found in process cheese, the pH was not able to be controlled and there was no correlation derived between pH and crumbly texture. However, the performance of cotija process cheese products with moisture level below 38 percent and pH below 5.7 appeared to mimic its natural counterpart.

Results:

Table 1 below provides a listing of the process cheese samples tested in Trials 1-3, along with their freezing conditions, time to reach equilibrium, and composition information for moisture, fat, salt, as well as pH level.

TABLE 1
Crumble Process Cheese Performance and Analytical Summary

| | Process | | | Time to | | | | |
|---|---|---|---|---|---|---|---|---|
| | Cheese | Cooling | Cooling | equilibrium | | | | |
| Trial | Sample | Condition | T (° F.) | (days) | Moisture | Fat | Salt | pH |
| 1 | Blue | Slow | 24 | 4.6 | 40.0 | 30.7 | 2.0 | 6.2 |
| | Blue | Fast | 24 | 1.5 | 39.8 | 31.0 | 2.0 | 6.2 |
| | Blue | Slow | 0 | 7 | 39.4 | 31.7 | 1.9 | 6.2 |
| | Blue | Fast | 0 | 4.2 | 40.0 | 30.5 | 1.9 | 6.2 |
| | Feta | Slow | 24 | 4.6 | 39.5 | 30.7 | 1.8 | 6.1 |
| | Feta | Fast | 24 | 1.5 | 39:6 | 31.1 | 1.8 | 6.1 |
| | Feta | Slow | 0 | 7 | 39.3 | 30.7 | 1.8 | 6.1 |
| | Feta | Fast | 0 | 4.2 | 39.3 | 31.1 | 1.8 | 6.2 |
| | Queso | Slow | 24 | 4.6 | 40.4 | 30.7 | 1.7 | 6.3 |
| | Fresco | | | | | | | |
| | Queso | Fast | 24 | 1.5 | 40.4 | 30.7 | 1.7 | 6.3 |
| | Fresco | | | | | | | |
| | Queso | Slow | 0 | 7 | 40.6 | 30.3 | 1.7 | 6.3 |
| | Fresco | | | | | | | |
| | Queso | Fast | 0 | 4.2 | 40.5 | 30.9 | 1.7 | 6.3 |
| | Fresco | | | | | | | |
| 2 | Cotija | Slow | 0 | 7 | 37.2 | 29.8 | 2.3 | 5.7 |
| | Cotija | Fast | 0 | 2.3 | 37.2 | 30.4 | 2.4 | 5.7 |
| | Cotija | Slow | −20 | 7 | 37.5 | 29.6 | 2.4 | 5.6 |
| | Cotija | Fast | −20 | 1.8 | 37.3 | 29.6 | 2.4 | 5.7 |
| | Queso | Slow | 0 | | 38.9 | 28.9 | 2.3 | 5.8 |
| | Fresco | | | | | | | |
| | Queso | Fast | 0 | 2.3 | 39.0 | 29.6 | 2.2 | 5.8 |
| | Fresco | | | | | | | |
| | Queso | Slow | −20 | 9 | 38.9 | 30.0 | 2.2 | 5.8 |
| | Fresco | | | | | | | |
| | Queso | Fast | −20 | 1.8 | 39.0 | 9.0 | 2.2 | 5.8 |
| | Fresco | | | | | | | |
| 3 | Queso | Fast | −20 | 1.8 | 39.0 | 29.8 | 2.3 | 5.8 |
| | Fresco- | | | | | | | |
| | control | | | | | | | |
| | Queso | Fast | −20 | 1.8 | 38.9 | 29.8 | 2.3 | 5.8 |
| | Fresco-pH 1 | | | | | | | |
| | Queso | Fast | −20 | 1.8 | 39.2 | 30.3 | 2.4 | 5.6 |
| | Fresco-pH 2 | | | | | | | |
| | Queso | Fast | −20 | 1.8 | 39.4 | 29.6 | 2.3 | 5.7 |
| | Fresco-pH 3 | | | | | | | |
| | Cotija- | Fast | −20 | 1.8 | 38.0 | 29.3 | 2.5 | 5.9 |
| | control | | | | | | | |
| | Cotija-pH 1 | Fast | −20 | 1.8 | 38.9 | 28.7 | 2.4 | 5.7 |
| | Cotija-pH 2 | Fast | −20 | 1.8 | 37.8 | 29.5 | 2.5 | 5.6 |
| | Cotija-pH 3 | Fast | −20 | 1.8 | 37.6 | 29.3 | 2.5 | 5.7 |
| | Feta-control | Fast | −20 | 1.8 | 37.7 | 29.9 | 2.3 | 5.9 |
| | Feta-pH 1 | Fast | −20 | 1.8 | 38.2 | 29.0 | 2.4 | 5.8 |
| | Feta-pH 2 | Fast | −20 | 1.8 | 37.9 | 30.2 | 2.3 | 5.7 |
| | Feta-pH 3 | Fast | −20 | 1.8 | 38.2 | 29.1 | 2.9 | 5.7 |

Summary:

The results of the trials show that samples subjected to cooling temperatures below normal refrigeration temperatures, e.g., below 38-40° F., particularly at or below freezing temperatures of 32° F. provide a process cheese with a crumble-like texture similar to natural cheese counterparts. In some aspects, the crumble products with a pH between 5.6-5.75, and moisture content between about 37 and about 38 percent that were subjected to −20° F. at fast freezing conditions using circulating air and held for 5 or more days had a texture that was most similar to the natural cheese counterparts. In addition, increasing the protein and decreasing the fat may result in the crumbled process cheese appearing like natural cheese. Higher amounts of protein (or lower moisture/fat content) in the product appears to result in a crumble process cheese product that is more similar to the natural cheese counterpart as protein is the main structural component of the product, and when the water freezes within the product, the ice crystals breakdown/disrupt more protein bonds resulting in an increased level of and firmer, less moist, crumbles. The time to reach temperature freezing temperature equilibrium may affect the performance of the process cheese, and samples subjected to more rapid cooling conditions, e.g., freezing over the course of about 45 hours, performed better compared to slower cooling conditions. In addition, freezing temperatures may also affect performance of the crumble products and process cheese frozen at lower freezing temperatures may perform better compared to elevated freezing temperatures.

While several advantages provided by products and processes of the various implementations are disclosed, additional advantages will be apparent in view of the disclosure herein.

The compositions, apparatuses and functions of the various implementations may be used interchangeably to form alternative implementations, as would be appreciated by those skilled in the art. Although the present disclosure provides references to preferred embodiments, persons skilled in the art will recognize that changes may be made in form and detail without departing from the spirit and scope of the invention.

What is claimed is:

1. A method of producing a crumble process cheese, comprising:
forming process cheese comprising an emulsion of an emulsifier, protein, water and oil, wherein the protein is bound to the water and the oil in the emulsification; and
cooling the process cheese to a freezing temperature below about 32° F. during an equilibration period, the equilibration period sufficient to cause a freeze-induced protein denaturation thereby producing a modified process cheese comprising a texture adapted to crumble.

2. The method of claim 1, wherein the freezing temperature ranges from below about 32° F. to about −20° F.

3. The method of claim 1, wherein the equilibration period is at least about 18 hours.

4. The method of claim 3, wherein the equilibration period is up to about 168 hours.

5. The method of claim 1, wherein the equilibration period is at least about 120 hours.

6. The method of claim 1, wherein cooling comprises cooling the process cheese in a temperature-controlled environment.

7. The method of claim 6, wherein the formed process cheese comprises a temperature of about 165° F. upon introduction into the temperature-controlled environment.

8. The method of claim 1, further comprising elevating a temperature of the modified process cheese to refrigeration temperatures.

9. The method of claim 8, wherein the refrigeration temperatures ranges from about 38° F. to about 40° F.

10. The method of claim 9, wherein the modified process cheese reaches refrigeration temperatures after at least about 24 hours.

11. The method of claim 9, wherein the modified process cheese reaches refrigeration temperatures after at least about 36 hours.

12. The method of claim 1, wherein cooling the process cheese further comprises cooling in an insulated environment.

13. The method of claim 1, further comprising packaging the formed process cheese at a temperature of about 165° F. and placing the packaged cheese having the temperature of about 165° F. in a temperature-controlled environment for cooling.

14. The method of claim 13, wherein the temperature-controlled environment is held at the freezing temperature.

15. The method of claim 14, wherein the freezing temperature comprises a temperature ranging from below about 32° F. to about −20° F.

16. A crumble process cheese product comprising an emulsifier, protein, water and oil, wherein a portion of the protein comprises casein and is bound to the oil and the water in an emulsion, and another portion of the casein is bound to the oil and is unbound to the water, thereby providing the crumble cheese product with a crumble-like texture.

17. The product of claim 16, further comprising a moisture content of about 33 to about 42 percent by weight of the product.

18. The product of claim 16, further comprising a pH of about 5.4 to about 5.6.

19. The product of claim 16, wherein the oil comprises fat, and the crumble process cheese product ranges from about 25 to 34 percent fat by weight of the product.

20. The product of claim 16, wherein the protein ranges from about 15 to 24 percent protein by weight of the product.
